(19) United States
(12) Patent Application Publication
(10) Pub. No.: US 2005/0105183 A1
(43) Pub. Date: May 19, 2005

(54) Lens and optical head device

(76) Inventor: Kenichi Hayashi, Nagano (JP)

Correspondence Address: Gerald H. Kiel, Esq.;REED SMITH LLP, 599 Lexington Avenue, New York, NY, 10022-7650, US

(21) Appl. No.: 10/959,807

(22) Filed: Oct. 6, 2004

(30) Foreign Application Priority Data
Oct. 9, 2003 (JP) 2003-351069

(51) Int. Cl. G03H 1/02

(52) U.S. Cl. 359/571; 359/642

(57) ABSTRACT

A lens including a diffraction grating formed on the inner side area and the outer peripheral side area of the refraction face in a concentrically circular shape around its optical axis such that a plurality of light beams with different wavelengths are focused at different positions. The diffraction grating of both the inner side area and the outer peripheral side area is formed so as to have the same blaze height “h”, which is set to be coincided with or approximated to both the values “h₁” and “h₂”, which are obtained by the following conditional expressions:
h₁=(m₁×λ₁)/(n−1) the conditional expression (1):
h₂=(m₂×λ₂)/(n2−1) the conditional expression (2):
wherein “m₁” is an integer number of 1 or more, “m₂” is an integer number more than “m₁”, “λ₁” is a wavelength of the first light beam, “λ₂” is a wavelength of the second light beam, “n₁” is a refractive index of the refraction face to the first light beam, and “n₂” is a refractive index of the refraction face to the second light beam.

### CROSS-REFERENCE TO RELATED APPLICATIONS

This application claims priority to Japanese Application No. 2003-351069 filed Oct. 09, 2003, which is incorporated herein by reference.

### FIELD OF THE INVENTION

The present invention relates to a lens with which light beams with different wavelengths are converged at different focal points by diffracting action and an optical head device using the lens. More specifically, the present invention relates to an optimization technique of diffraction grating formed on the refraction face of a lens.

### BACKGROUND OF THE INVENTION

Optical recording media such as a CD (CD-R is included) and a DVD having transparent protective layers with different thickness for protecting their recording surfaces and having different recording densities are known. A laser light source for CD emitting a laser beam with a wavelength of 785 nm is used to reproduce and record data on a CD and a laser light source for DVD emitting a laser beam with a wavelength of 655 nm is used to reproduce data from a DVD. A conventional optical head device for performing recording and reproduction of information on or from such two types of optical recording media is, for example, constructed such that a laser beam converges on the recording surface of a CD or a DVD by using a common objective lens to attain its miniaturization and compactness.

The thickness of the transparent protective layer of a CD for protecting its recording surface is 1.2 mm. The thickness of the transparent protective layer of a DVD is 0.6 mm, which is thinner than that of the CD, and its recording density is higher than that of a CD. Therefore, an objective lens is formed such that a diffraction grating including a concentrically circular fine grating is formed on a lens surface having a single refracting power. A plurality of focal points are formed on different positions on the optical axis by diffracting incident light beams with the diffraction grating in addition to the refraction of the lens surface. Further, in the objective lens using diffraction together (diffraction parallel use type objective lens), optimization is performed with respect to both the CD and the DVD by dividing the region of refraction face based on the numerical aperture of a CD to reduce the aberration as a whole (see, for example, U.S. Pat. No. 2,922,851).

Since the objective lens always forms two focal points, both the operating distances for a CD and a DVD can be the same as shown in FIGS. 8(a) and 8(b). Therefore, it is advantageous to reduce the thickness of an optical head device.

However, since different diffraction orders of the laser beam with the same wavelength are used for a CD and a DVD in the objective lens, the utilization efficiency of the light beam is low. On the other hand, when the light source is activated with a high power to enhance the utilization efficiency of the light beam, the service life of the light source may shorten or diffracted light which is not used may cause a noise.

An objective lens has been proposed in which two types of laser beams with different wavelength are used and their diffraction orders are set to be the same to enhance the utilization efficiency of the light beams and, in addition, to form satisfactorily focal points on the recording surfaces of a CD and a DVD (see, for example, Japanese Patent Laid-Open No. 2000-81566).

However, in the optical head device provided with the objective lens as described in the Japanese Patent Laid-Open No. 2000-81566, as shown in FIGS. 8(a) and 8(c), the thickness difference of the transparent protective layers of a CD and a DVD is required to be compensated by a positional shift in the focus direction of the objective lens (optical axis direction of objective lens). Therefore, the amount of the lens shift due to the difference of the thicknesses of the transparent protective layers of the optical recording media has to be added to an operating distance for a normal focus control in the movable range of the objective lens in the focus direction. The problem described above causes the limitation of reducing the thickness of an optical head device.

### SUMMARY OF THE INVENTION

In view of the problems described above, it is a primary object and advantage of the present invention to provide a lens with which a plurality of laser beams can efficiently converge at prescribed positions by optimizing the construction of diffraction grating to the laser beams with different wavelengths without increasing the movable range in the focus direction, and an optical head device mounted with the lens.

In order to achieve the above object and advantage, according to an embodiment of the present invention, there is provided a lens including a refraction face having an inner side area and an outer peripheral side area surrounding the inner side area and a diffraction grating formed on the inner side area and the outer peripheral side area of the refraction face in a concentrically circular shape around its optical axis such that a plurality of light beams with different wavelengths are focused at different positions. The plurality of light beams include a first light beam, which emits through the inner side area of the refraction face, and a second light beam with a wavelength shorter than a wavelength of the first light beam, which emits through the inner side area and the outer peripheral side area. The diffraction grating of both the inner side area and the outer peripheral side area is formed to have the same blaze height “h”, and the blaze height “h” is set to be coincided with (“h1”=“h2”) or approximated to both the values “h1” and “h2”, which are obtained by the following conditional expressions (1) and (2).
h₁=(m₁×λ₁)/(n₁−1) The conditional expression (1):
wherein “m₁” is an integer number of 1 or more,
“λ₁” is a wavelength of the first light beam,
“n₁” is a refractive index of the refraction face to the first light beam.
   h₂=(m₂×λ₂)/(n₂−1) The conditional expression (2):
   wherein “m₂” is an integer number more than “m₁”,
“λ₂” is a wavelength of the second light beam,
“n₂” is a refractive index of the refraction face to the second light beam.
   In other words, “m₁” and “m₂” are the diffraction orders of the first and the second light beams, and the values “h₁” and “h₂” are the blaze heights corresponding to the respective diffraction orders. Accordingly, in accordance with an embodiment of the present invention, “m₁” and “m₂” are variously changed, and “m₁” and “m2” are set such that “m₂” is a larger integer number than “m₁” and such that the values “h₁” and “h₂” are approximated to each other. Then, the height which is coincided with or approximated to the both values “h₁” and “h₂” is set to be the blaze height “h”. When “m₂” and “m₁” are set to be equal, in other words, when both the diffraction orders are the same, the difference of the thicknesses of the transparent protective layers like a CD and a DVD is required to be compensated by a positional shift in the focus direction of the objective lens (the optical axis direction of the objective lens) as described above. Accordingly, “m₂” and “m₁” are set to be different.

In accordance with an embodiment of the present invention, it is preferable that the blaze height “h” substantially coincides with one of the values “h₁” and “h₂” and approximates to the other of the values “h₁” and “h₂”. Concretely, the blaze height “h” is set in a value between the values “h₁” (included) and “h₂” (included). In other words, it is preferable to substantially optimize the blaze height for the light beam having a higher priority either of the first light beam or the second light beam. Normally, since the light beam with a shorter wavelength is used for recording or reproduction for an optical recording medium with a high recording density, it is preferable that the second light beam, i.e., the light beam with a shorter wavelength is prior to the first light beam and thus the blaze height is optimized to the second light beam.

The first light beam and the second light beam in accordance with an embodiment of the present invention do not always mean that only two types of light beams are incident on a lens. In accordance with an embodiment of the present invention, two or more light beams may be used and one with a longer wavelength is defined as the first light beam and another with a shorter wavelength is defined as the second light beam. Accordingly, in the present invention, a plurality of light beams incident on a lens may comprise two types of light beams with different wavelengths and, in addition, three or more types of light beams with different wavelengths. When the plurality of light beams comprise three types of light beams with different wavelengths, when the laser beam with a longer wavelength is defined as a first laser beam and the laser beam with a shorter wavelength is defined as a second laser beam in either two of light beams of the three types of laser beams, the blaze height “h” may be set to satisfy the conditional expressions (1) and (2). Alternatively, in selected only two of the three types of laser beams, the blaze height “h” may be set to satisfy the conditional expressions (1) and (2).

In accordance with an embodiment of the present invention, when the light beams include at least light beams used for recording or reproduction for a CD or a DVD, it is preferable that either one of boundaries between the inner side area and its outside and between the outer peripheral side area and its outside corresponds to a numerical aperture of the light beam used for recording or reproduction for the CD or the DVD. When the area is divided as described above, it is advantageous in that design for making aberration small is easy for every optical recording media such as a CD and a DVD.

In accordance with an embodiment of the present invention, when the light beams include at least a light beam used for recording or reproduction for a CD as the first light beam and a light beam used for recording or reproduction for a DVD as the second light beam, the values “m₁” and “m₂” preferably satisfy the following conditional expression: m₂=m₁−1. In other words, the blaze height of the diffraction grating is optimized to each diffracted light of the first light beam used for recording or reproduction for a CD and the second light beam used for recording or reproduction for a DVD. However, the diffracted light of the first light beam is preferably optimized such that the order of diffracted light of the first laser beam is lower by one order than that of the second laser beam.

In accordance with an embodiment of the present invention, when the light beams include at least a light beam used for recording or reproduction for a CD as the first light beam and a light beam used for recording or reproduction for a DVD as the second light beam, preferably the blaze height “h” substantially coincides with the value “h₂” for the DVD and approximates to the value “h1” for the CD. In other words, it is preferable that the blaze height is optimized to the second light beam from the viewpoint that the DVD, which is an optical recording medium with a higher recording density, is prior to the CD.

According to an embodiment of the present invention, there is provided an optical head device provided with the lens in accordance with the embodiments of the present invention. In other words, the lens in accordance with the embodiment of the present invention is used as a common objective lens through which the first light beam converges on the recording surface of the first optical recording medium and the second light beam converges on the recording surface of the second optical recording medium whose thickness of the transparent protective layer covering the recording surface is thinner than that of the first optical recording medium.

As described above, in accordance the present invention, since the different focal positions are formed for the different laser beams with different wavelengths by using the diffraction parallel use type objective lens, even when the laser beams converge on the optical recording media having transparent protective layers with a different thickness, the difference of the thicknesses of transparent protective layers is not required to compensate with a positional shift in the focus direction of the objective lens (optical axis direction of the objective lens). Accordingly, in the movable range of the objective lens in the focus direction, the lens shift amount due to the thickness difference of the transparent protective layers of the optical recording media is not required to be added in the operating distance for a normal focus control, and thus the thickness of the optical head device can be reduced. Further, in the embodiment of the present invention, although the same blaze height “h” is set in the entire area, the orders of the diffracted lights used in the laser beams with different wavelengths are set to be different from each other. Therefore, since a high degree of diffraction efficiency can be set for either of the laser beams, a high degree of utilization efficiency of the light beam is attained.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a schematic construction view showing mainly the optical system of an optical head device in accordance with a first embodiment of the present invention;

FIG. 2(a) is a plan view showing an objective lens in accordance with the first embodiment, FIG. 2(b) is its cross-sectional view, FIG. 2(c) is a partly enlarged cross-sectional view showing a center side refraction face area around the optical axis, and FIG. 2(d) is a partly enlarged cross-sectional view showing an outer side refraction face area surrounding the center side refraction face area;

FIG. 3 is an explanatory schematic view showing converging states of respective laser beams with the objective lens shown in FIGS. 2(a) through 2(d);

FIG. 4 is an explanatory tabular view showing the relationship between the diffraction orders of respective laser beams incident on the objective lens shown in FIGS. 2(a) through 2(d) and blaze heights corresponding to the diffraction order;

FIG. 5(a) is a plan view showing an objective lens in accordance with a second embodiment of the present invention, FIG. 5(b) is its cross-sectional view, FIG. 5(c) is a partly enlarged cross-sectional view of a center side refraction face area around the optical axis, FIG. 5(d) is a partly enlarged cross-sectional view on an inner portion in an outer side refraction face area surrounding the center side refraction face area, and FIG. 5(e) is a partly enlarged cross-sectional view on an outer peripheral side portion in the outer side refraction face area;

FIG. 6 is an explanatory schematic view showing converging states of respective laser beams with the objective lens shown in FIGS. 5(a) through 5(e);

FIG. 7 is an explanatory tabular view showing the relationship between the diffraction orders of respective laser beams incident on the objective lens shown in FIGS. 5(a) through 5(e) and blaze heights corresponding to the diffraction order; and

FIGS. 8(a) through 8(c) are explanatory schematic views showing a lens shift performed to an objective lens when recording or reproduction is performed for a CD or a DVD.

### DETAILED DESCRIPTION OF THE PREFERRED EMBODIMENTS

An optical head device including an objective lens to which the present invention is applied will be described below with reference to the accompanying drawings.

### First Embodiment

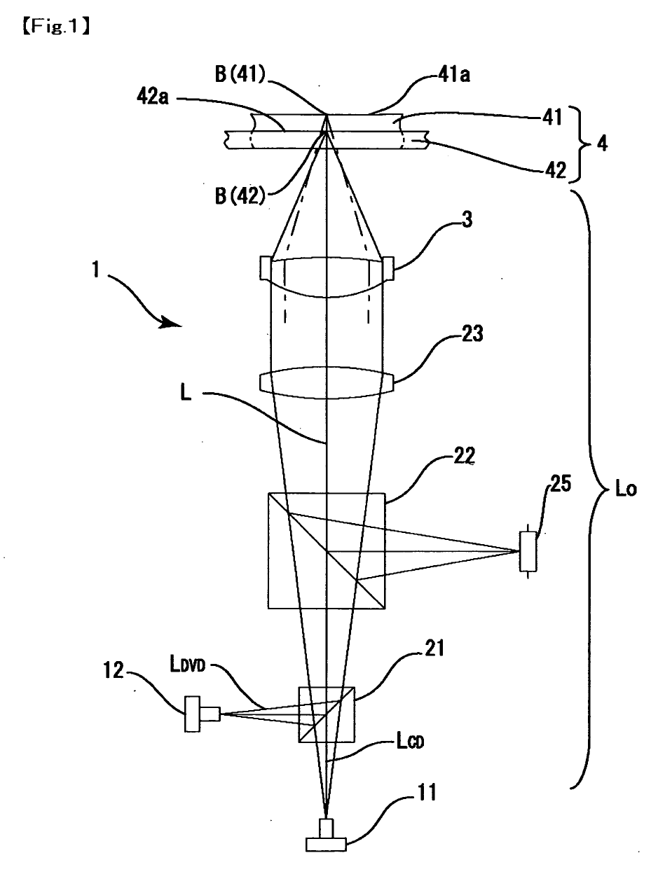

FIG. 1 is a schematic construction view showing mainly the optical system of an optical head device in accordance with a first embodiment of the present invention. In FIG. 1, the optical head device 1 in accordance with the first embodiment performs reproduction or recording information to two types of optical recording media 4 with different substrate thicknesses and recording densities such as a CD or a DVD. Therefore, a laser light source 11 is provided, which emits a laser beam L_{CD} for CD with a center wavelength of 785 nm used for recording or reproducing data on or from a CD or the like, and a laser light source 12 is provided, which emits a laser beam L_{DVD} for DVD with a wavelength of 655 nm used for reproducing or the like data from a DVD. The respective laser beams are guided to the optical recording medium 4 through a common light converging optical system Lo and the return light beams of the respective laser light beams reflected by the optical recording medium 4 is guided to a common light receiving element 25.

The light converging optical system Lo includes a first beam splitter 21 which advances the laser beam L_{CD} straight and reflects the laser beam L DVD to align both the light beams on the system optical axis “L” (optical axis of objective lens), a second beam splitter 22 through which the laser beams L_{CD} and L_{DVD} advancing along the system optical axis L are passed, a collimator lens 23 for making parallel the laser beams L_{CD} and L_{DVD} passing through the second beam splitter 22, and an objective lens 3 for forming a beam spot of the laser beam L_{CD} or the laser beam L_{DVD} emitted from the collimator lens 23 on the recording surface of the optical recording medium 4.

In the optical head device 1 as constructed above, the beam spot B(41) of the laser beam L_{CD} is formed on the recording surface 41a of a CD 41 as a first optical recording medium 4 by the objective lens 3. Also, the beam spot B(42) of the laser beam L_{DVD} is formed on the recording surface 42a of a DVD 42 as a second optical recording medium 4 by the objective lens 3.

After the laser beam L_{CD} for CD or the laser beam L_{DVD} for DVD converged on the optical recording medium 4 (CD 41, DVD 42) are respectively reflected by the optical recording medium 4, they return the common light converging optical system Lo as a return light beam in a reverse manner and are reflected by the second beam splitter 22 to converge on the common light receiving element 25. Reproduction or the like of information from the optical recording medium 4 (CD 41, DVD 42) is performed by the signal which is detected with the common light receiving element 25.

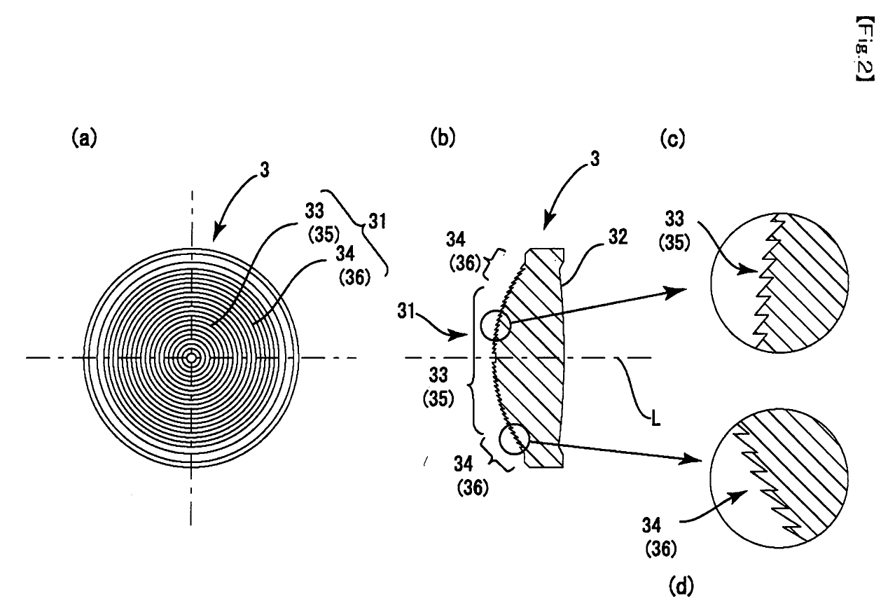

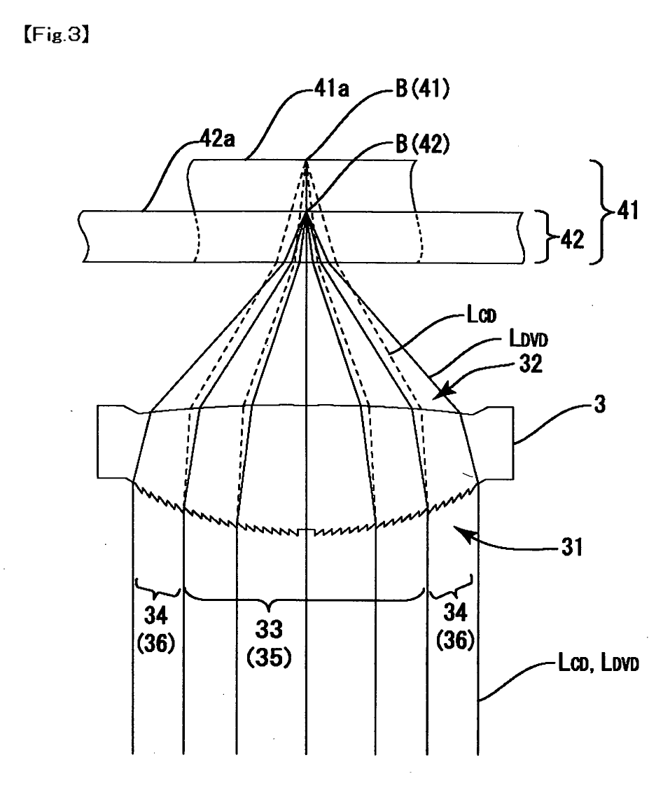

The construction of the objective lens 3 in the first embodiment will be described in detail with reference to FIGS. 2(a) through 2(d) and FIG. 3. FIG. 2(a) is a plan view showing the objective lens 3, FIG. 2(b) is its cross-sectional view, FIG. 2(c) is a partly enlarged cross-sectional view showing a center side refraction face area around the optical axis, and FIG. 2(d) is a partly enlarged cross-sectional view showing an outer side refraction face area surrounding the center side refraction face area. FIG. 3 is an explanatory view showing converging states of respective laser beams with the respective wavelengths by using the objective lens 3.

In FIGS. 2(a) through 2(d), the objective lens 3 in the first embodiment is the convex lens including an incident side refraction surface 31 formed of an aspheric surface having a positive power where the laser beam L_{CD} or L_{DVD} is incident and an emitting side refraction face 32 formed of an aspheric surface where the laser light beam is emitted to the optical recording medium 4.

The incident side refraction surface 31 is divided into two areas, that is, a concentrically circular center side refraction face area 33 (inner side area) including and around the optical axis “L” and an outer side refraction face area 34 (outer peripheral side area) surrounding the outer periphery of the center side refraction face area 33 in a ring-shaped manner. The boundary portion of the center side refraction face area 33 and the outer side refraction face area 34 is the position corresponding to the numerical aperture NA=0.45˜0.55 for CD 41 (laser beam L_{CD} for CD).

A center side diffraction grating 35 comprising a plurality of fine concentric circular steps in a saw-tooth shape is formed over the whole area of the center side refraction face area 33. An outer peripheral side diffraction grating 36 comprising a plurality of fine concentric circular steps in a saw-tooth shape is formed over the whole area of the outer side refraction face area 34. Therefore, the objective lens 3 is constructed as a lens used together with diffraction (diffraction parallel use type objective lens).

As also described in FIG. 3, the center side diffraction grating 35 formed on the center side refraction face area 33 is provided with a diffraction characteristic that the beam spot B(41) by the diffracted light (shown by the dotted line in FIG. 3) of the laser beam L_{CD} passing through the area 33 is formed on the recording surface 41a of the CD 41. In addition, the center side diffraction grating 35 formed on the center side refraction face area 33 is provided with a diffraction characteristic that the beam spot B(42) by the diffracted light (shown by the solid line in FIG. 3) of the laser beam L_{DVD} passing through the area 33 is formed on the recording surface 42a of the DVD 42.

The outer peripheral side diffraction grating 36 formed on the outer side refraction face area 34 is provided with a diffraction characteristic that the beam spot B(42) by the diffracted light of the laser beam L_{DVD} passing through the area 34 is formed on the recording surface 42a of the DVD 42.

The beam component of the laser beam L_{CD} passing through the outer side refraction face area 34 is the unnecessary beam component which does not contribute to recording or reproduction. In this embodiment, the beam component is diffracted not to converge at the beam spot forming position on the recording surface 41a of the CD 41 due to diffracting action by the outer peripheral side diffraction grating 36 formed on the outer side refraction face area 34.

In the objective lens 3 in the first embodiment, the saw-tooth shaped step constructing the center side diffraction grating 35 has the same blaze height as that of the saw-tooth shaped step constructing the outer peripheral side diffraction grating 36. The blaze height is set to be the height such that the diffracted light of the laser beam L_{CD} through the center side diffraction grating 35 and the diffracted light of the laser beam L_{DVD} through the center side diffraction grating 35 and the outer peripheral side diffraction grating 36 respectively converge at prescribed focal positions with a high degree of diffraction efficiency. For this purpose, the optimal blaze height is obtained for every diffraction order by wavelengths of the laser beams, and the value which approximates the respective optimal blaze heights is set as the blaze height for the center side diffraction grating 35 and the outer peripheral side diffraction grating 36.

In other words, two types of the laser beams with different wavelengths are incident on the objective lens 3 in the present embodiment. Therefore, when the laser beam L_{CD} with a longer wavelength is defined as a first laser beam and the laser beam L_{DVD} with a shorter wavelength is defined as a second laser beam, the blaze height “h” of the center side diffraction grating 35 and the outer peripheral side diffraction grating 36 is set to be coincided with or approximated to both the values “h₁” and “h₂”, which are obtained by the following conditional expressions:
h₁=(m₁×λ₁)/(n₁−1) The conditional expression (1):
wherein “m₁” is an integer number of 1 or more,
“λ₁” is a wavelength of the first light beam,
“n₁” is a refractive index of the refraction face to the first light beam,
   h₂=(m₂×λ₂)/(n₂−1) The conditional expression (2):
   wherein “m₂” is an integer number more than “m₁”,
“λ₂” is a wavelength of the second light beam,
“n₂” is a refractive index of the refraction face to the second light beam.
   Here, “m₁” and “m₂” are respectively the diffraction order of the first light beam and the diffraction order of the second light beam, and the values “h₁” and “h₂” are the blaze heights corresponding to the respective diffraction orders. Therefore, in the first embodiment, the numbers of “m₁” and “m₂” are variously changed and are set such that the values “h₁” and “h₂” are approximated to each other, and the height which is coincided with or approximated to the both values “h₁” and “h₂” is set to be the blaze height “h”.

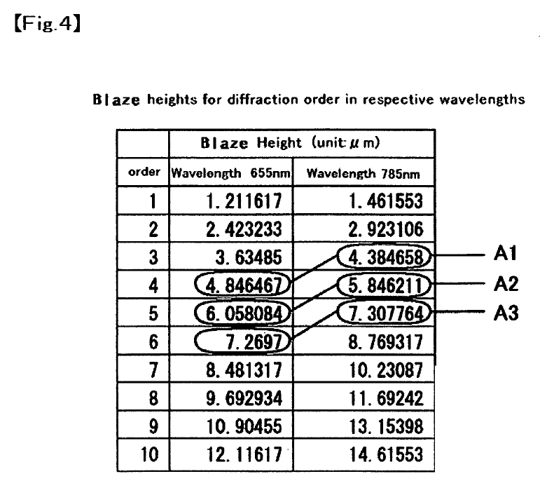

The setting method will be described more concretely with reference to FIG. 4. FIG. 4 is an explanatory view showing the relationship between the diffraction orders of the laser beams L_{CD} and L_{DVD} incident on the objective lens 3 and blaze heights corresponding to the diffraction order. FIG. 4 shows an example in which the objective lens 3 is molded with resin of olefin system. The refractive index of the resin of olefin system is 1.5406 with respect to the wavelength of 655 nm and 1.5371 with respect to the wavelength of 785 nm. Other than resin of olefin system, resin of fluorene system and resin of norbornene system are used for molding material of the objective lens 3.

As shown in FIG. 4, when the diffraction order is varied as the first, the second, the third, and the like with respect to the laser beam L_{CD} with the wavelength of 785 nm, the blaze height corresponding to the diffraction order varies as 1.461553 μm, 2.923106 μm, 4.384658 μm and the like. Further, when the diffraction order is varied as the first, the second, the third, and the like with respect to the laser beam L_{DVD} with the wavelength of 655 nm, the blaze height corresponding to the diffraction order varies as 1.211617 μm, 2.423233 μm, 3.63485 μm and the like. Therefore, the group that the blaze height corresponding to each diffraction order of the laser beam L_{CD} with the wavelength of 785 nm and the blaze height corresponding to each diffraction order of the laser beam L_{DVD} with the wavelength of 655 nm approximate to each other, in other words, are approximately equal to each other, is selected. Accordingly, the value coincided with or approximated to the both blaze heights is set to be the blaze height “h” of the center side diffraction grating 35 and the outer peripheral side diffraction grating 36.

For example, in the group “A1” shown in FIG. 4, when the diffraction order of the laser beam L_{CD} with the wavelength of 785 nm is set in the third order, its corresponding blaze height is 4.384658 μm and, when the diffraction order of the laser beam L_{DVD} with the wavelength of 655 nm is set in the fourth order, its corresponding blaze height is 4.846467 μm. Both the blaze heights approximate to each other or are approximately equal to each other. Therefore, the blaze height “h” of the center side diffraction grating 35 and the outer peripheral side diffraction grating 36 are set in the value, which is coincided with either of the blaze heights, or set in the value which is approximated between the blaze heights.

In this case, the simple average of the two blaze heights may be used as the blaze height “h”, but preferably the average obtained after performing weighting based on the respective priority degrees may be used. In addition, since the laser beam L_{DVD} with the shorter wavelength is for high recording density, the blaze height “h” may be preferably coincided with or approximated to 4.846467 μm, which is the blaze height corresponding to the fourth diffracted light of the laser beam L_{DVD}, by giving priority to a DVD.

When the blaze height “h” is determined based on the calculation results shown in FIG. 4, the groups “A2” or “A3” may be used in addition to the group “A1” shown in FIG. 4. In other words, a plurality of groups in which two blaze heights are approximated to each other are selected from the respective combinations of the blaze heights, and a suitable group is selected from the groups. In this case, when the blaze height “h” is set to be low, the diffracted light whose diffraction order is small is used. Therefore, it is preferable that the number of blaze can be increased and a higher diffraction efficiency can be obtained.

Further, in the calculation results shown in FIG. 4, it is preferable to use a group in which the values “m1” and “m2” used in the conditional expressions (1) and (2) satisfy the following conditional expression: m₂=m₁−1. In other words, it is preferable to use a group in which the order of diffracted light of the laser beam for CD is lower by one order than that of the laser beam for DVD.

As described above, in the optical head device 1 in accordance with the first embodiment, only the laser light source 11 for CD is driven and the laser beam L_{CD} is emitted at the time of reproducing information from the CD 41. As a result, as shown by the dotted line in FIG. 3, the laser beam L_{CD} passes the center side refraction face area 33 of the objective lens 3 and the beam spot B(41) is formed on the recording surface 41a of the CD 41 by the diffracted light component generated by the center side diffraction grating 35 formed on the objective lens 3.

On the other hand, only the laser light source 12 for DVD is driven and the laser beam L DVD is emitted at the time of reproducing information from the DVD 42. As a result, as shown by the solid line in FIG. 3, the laser beam L_{DVD} passes the center side refraction face area 33 and the outer side refraction face area 34 of the objective lens 3 and the beam spot B(42) is formed on the recording surface 42a of the DVD 42 by the diffracted light component generated by the center side diffraction grating 35 and the outer peripheral side diffraction grating 36 formed on the objective lens 3.

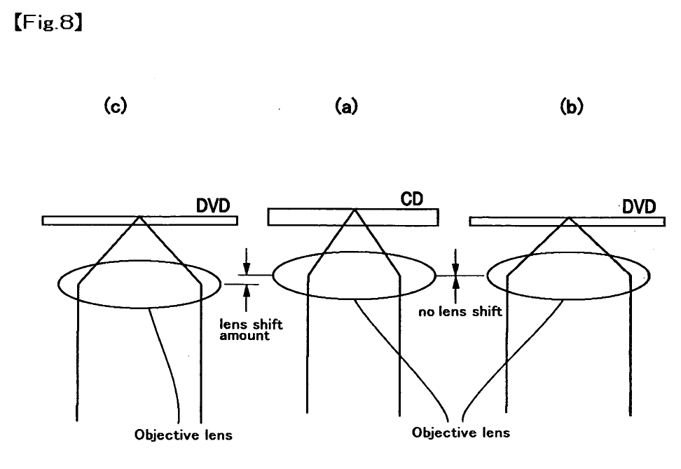

As described above, in the first embodiment, different focal positions are formed with the diffraction parallel use type objective lens 3 by using two different diffraction orders of the laser beams L_{CD} and L_{DVD} with different wavelengths. Therefore, as shown in FIGS. 8(a) and 8(b), even when the laser beams L_{CD} and L_{DVD} converge on the optical recording media with different thickness of a transparent protective layer, the difference of the thicknesses of transparent protective layers is not required to compensate with a positional shift in the focus direction of the objective lens 3 (optical axis direction of the objective lens). Therefore, in the movable range of the objective lens 3 in the focus direction, the width of lens shift due to the thickness difference of the transparent protective layers of the optical recording media is not required to be added to the operating distance for a normal focus control, and thus the thickness of the optical head device can be reduced. For example, since the operating distance of the objective lens 3 can be made smaller by 0.3˜0.4 mm in comparison with the case using a conventional objective lens, it is suitable for a notebook-sized personal computer or the like which is remarkably required to reduce its thickness.

In the first embodiment, the same blaze height “h” is set in either of the center side diffraction grating 35 and the outer peripheral side diffraction grating 36. However, since the orders of the diffracted lights used in two types of laser beams L_{CD} and L_{DVD} with different wavelengths differ from each other, a high degree of diffraction efficiency can be set for either of the laser beams L_{CD} and L_{DVD}. Accordingly, a high degree of utilization efficiency of the light beam is attained.

In addition, since the diffraction grating is formed on the entire surface of the refraction face of the objective lens 3, the occurrence of spherical aberration, which is caused by the wavelength variation of the laser beams L_{CD} and L_{DVD} and by the refractive index variation of the blank material of the objective lens 3 due to the temperature variation, can be restrained.

In the first embodiment of the present invention, the boundary position between the center side refraction face area 33 and the outer side refraction face area 34 in the incident side refraction surface 31 of the objective lens 3 is the position corresponding to the numerical aperture NA of the laser beam L_{CD}, i.e., NA=0.45˜0.55. Therefore, the objective lens 3 is easily designed such that the respective aberrations of the laser beams L_{CD} and L_{DVD} are reduced.

### Second Embodiment

In the optical head device in accordance with the first embodiment of the present invention, the objective lens 3 whose refraction face of the objective lens 3 is divided into two areas is commonly used to reproduce and record information for two types of different optical recording media of the CD 41 and DVD 42. Alternatively, when the refraction face of a objective lens is divided into three areas, information can be reproduced and recorded on three different types of optical recording media by using a common objective lens.

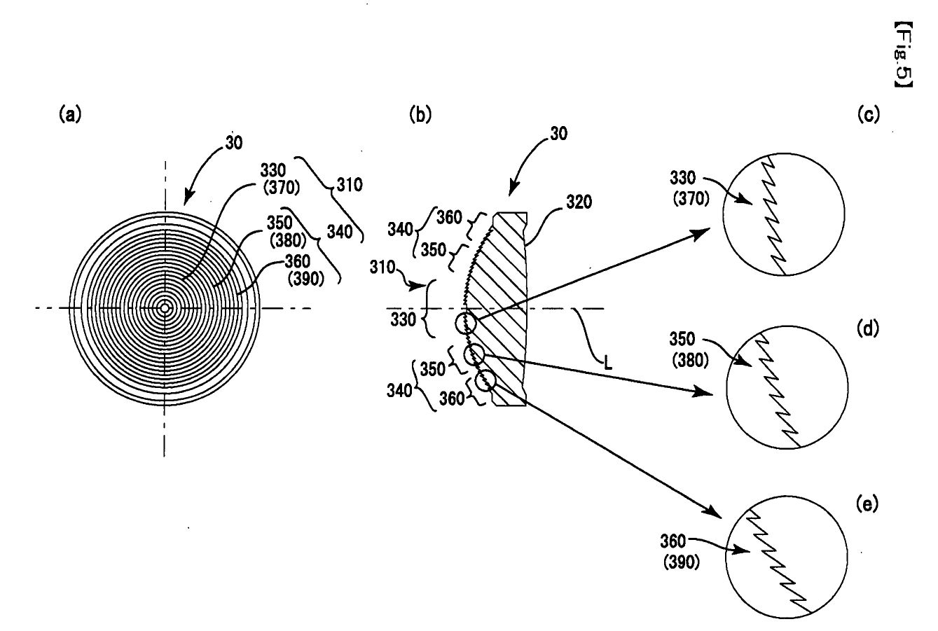

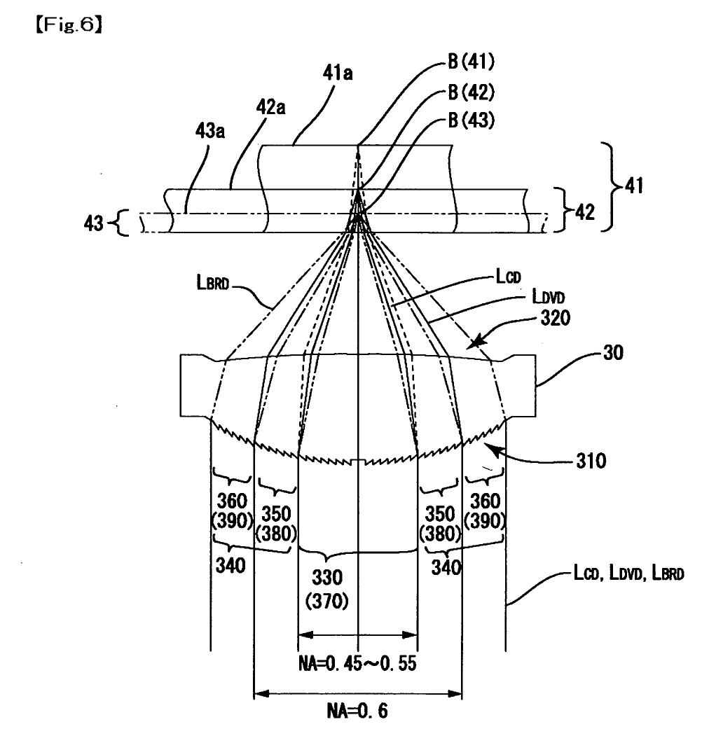

FIG. 5(a) is a plan view showing an objective lens in accordance with a second embodiment of the present invention, FIG. 5(b) is its cross-sectional view, FIG. 5(c) is a partly enlarged cross-sectional view of a center side refraction face area around the optical axis, FIG. 5(d) is a partly enlarged cross-sectional view on an intermediate portion in an outer side refraction face area surrounding the center side refraction face area, and FIG. 5(e) is a partly enlarged cross-sectional view on an outer peripheral portion in the outer side refraction face area surrounding the intermediate portion. FIG. 6 is an explanatory view showing converging states of respective laser beams with the objective lens shown in FIGS. 5(a) through 5(e).

The objective lens 30 shown in FIGS. 5(a) through 5(e) and FIG. 6 is mounted in an optical head device for reproducing and recording information on three types of optical recording media with different substrate thickness and different recording densities. For example, the laser beam L_{CD} with the center wavelength of 785 nm used to record and reproduce for the CD 41 or the like, the laser beam L_{DVD} with the wavelength of 655 nm used to reproduce or the like for the DVD 42, and the laser beam L_{BRD} with the center wavelength of 405 nm used to reproduce information for a BRD (Blu-ray Disc) 43 can be respectively converged on the corresponding recording surface of the optical recording media (CD 41, DVD 42, BRD 43). The BRD is an optical recording medium with a higher recording density and a thinner substrate thickness protecting recording surface than the DVD 42.

In FIGS. 5(a) through 5(e), the objective lens 30 in the second embodiment is a convex lens provided with an incident side refraction face 310 having a positive power on which the laser beams L_{CD}, L_{DVD} and L_{BRD} are incident, and an emitting side refraction face 320 emitting the laser light beam toward the optical recording medium 4.

The incident side refraction surface 310 is divided, as similar to the first embodiment, into a circular center side refraction face area 330 including the optical axis “L”, which is formed in a concentrically circular shape around the optical axis “L”, and an outer side refraction face area 340 surrounding the outer periphery of the center side refraction face area 330. The boundary portion between the center side refraction face area 330 and the outer side refraction face area 340 is the position corresponding to the following numerical aperture NA of the laser beam L_{CD}; NA=0.45˜0.55.

In addition, in the second embodiment, the outer side refraction face area 340 is divided into an intermediate area 350 on an inner peripheral side and a most outer peripheral area 360 surrounding the intermediate area 350. The boundary portion between the intermediate area 350 and the most outer peripheral area 360 is the position corresponding to the following numerical aperture of the laser beam L_{DVD}; NA=0.6˜0.65.

A center side diffraction grating 370 comprising a plurality of concentric circular fine steps in a saw-tooth shape is formed on the center side refraction face area 330 of the objective lens 30. An intermediate diffraction grating 380 comprising a plurality of concentric circular fine steps in a saw-tooth shape is formed on the intermediate area 350 of the outer side refraction face area 340. In addition, a most outer peripheral side diffraction grating 390 comprising a plurality of concentric circular fine steps in a saw-tooth shape is formed on the most outer peripheral area 360 of the outer side refraction face area 340.

As also shown in FIG. 6, the center side diffraction grating 370 has a diffraction characteristic such that the beam spot B(4 1) with the diffracted light of the laser beam L_{CD} passing through the area 330 (shown by the dotted line in FIG. 6) is formed on the recording surface 41a of the CD 41. The center side diffraction grating 370 has a diffraction characteristic such that the beam spot B(42) with the diffracted light of the laser beam L_{DVD} passing through the area 330 (shown by the solid line in FIG. 6) is formed on the recording surface 42a of the DVD 42. In addition, the center side diffraction grating 370 has a diffraction characteristic such that the beam spot B(43) with the diffracted light of the laser beam L_{BRD} passing through the area 330 (shown by the two-dot chain line in FIG. 6) is formed on the recording surface 43a of the BRD 43.

The intermediate diffraction grating 380 has a diffraction characteristic such that the beam spot B(43) with the diffracted light of the laser beam L_{DVD} passing through the area 350 is formed on the recording surface 42a of the DVD 42. In addition, the intermediate diffraction grating 380 has a diffraction characteristic such that the beam spot B(43) with the diffracted light of the laser beam L_{BRD} passing through the area 350 is formed on the recording surface 43a of the BRD43.

The most outer peripheral side diffraction grating 390 has a diffraction characteristic such that the beam spot B(43) with the diffracted light of the laser beam L_{BRD} passing through the area 360 is formed on the recording surface 43a of the BRD43.

The beam component of the laser beam L_{CD} passing through the outer side refraction face area 340 is the unnecessary optical component, which does not contribute to recording or reproduction. In the second embodiment, the beam component is diffracted so as not to converge at the beam spot forming position on the recording surface 41a of the CD 41 by being diffracted by the intermediate diffraction grating 380 and the most outer peripheral side diffraction grating 390. The beam component of the laser beam L_{DVD} passing through the most outer peripheral area 360 is the unnecessary optical component, which does not contribute to recording or reproduction and, in the second embodiment, is diffracted so as not to converge at the beam spot forming position on the recording surface 42a of the DVD 42 by being diffracted by the most outer peripheral side diffraction grating 390.

Also, in the objective lens 30 in the second embodiment, the saw-tooth shaped step constructing the center side diffraction grating 370, the saw-tooth shaped step constructing the intermediate diffraction grating 380, and the saw-tooth shaped step constructing the most outer peripheral side diffraction grating 390 are respectively formed in the same or substantially same blaze height. The blaze height is set to be the height such that the diffracted light of the laser beam L_{CD}, the diffracted light of the laser beam L_{DVD}, and the diffracted light of the laser beam L_{BRD} respectively converge at prescribed focal positions with a high degree of diffraction efficiency. For this purpose, the optimal blaze height is obtained for every diffraction order by wavelengths of the laser beams, and the value approximating the respective optimal blaze heights is set as the blaze height for the center side diffraction grating 370, the intermediate diffraction grating 380 and the most outer peripheral side diffraction grating 390.

In other words, three types of the laser beams L_{CD}, L_{DVD} and L_{BRD} with different wavelengths are incident on the objective lens 30 in the second embodiment. In this case, when the laser beam with a longer wavelength is defined as a first laser beam and the laser beam with a shorter wavelength is defined as a second laser beam in either two types of light beams of the above-mentioned three kinds of laser beams L_{CD}, L_{DVD} and L_{BRD}, the blaze height “h” is set to be coincided with or approximated to both the values “h₁” and “h₂”, which are obtained by the following conditional expressions:
h₁=(m₁×λ₁)/(n₁−1) The conditional expression (1):
wherein “m₁” is an integer number of 1 or more,
“λ₁” is the wavelength of the first light beam,
“n₁” is the refractive index of the refraction face to the first light beam
   h₂=(m₂×λ₂)/(n₂−1) The conditional expression (2):
   wherein “m₂”is an integer number more than “m1”,
“λ₂” is the wavelength of the second light beam,
“n₂” is the refractive index of the refraction face to the second light beam.
   Here, “m₁” and “m₂” are respectively the diffraction orders of the first and the second light beams, and the values “h₁” and “h₂” are the blaze heights corresponding to the respective diffraction orders. Therefore, in the second embodiment, the numbers of “m₁” and “m₂” are variously changed and set such that the values “h₁” and “h₂” are approximated to each other, and the height which is coincided with or approximated to the both values “h₁” and “h₂” is set to be the blaze height “h”.

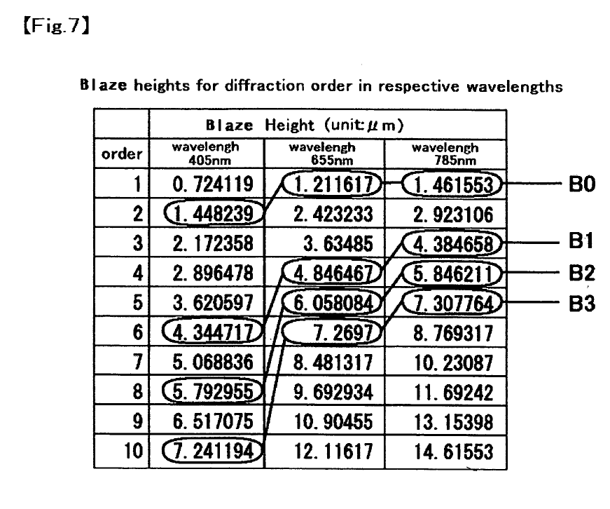

The setting method will be described more concretely with reference to FIG. 7. FIG. 7 is an explanatory view showing the relationship between the diffraction orders of the laser beams L_{CD}, L_{DVD} and L_{BRD} incident on the objective lens 30 and blaze heights corresponding to the diffraction order. FIG. 7 shows an example in which the objective lens 30 is molded with resin of olefin system. The refractive index of the resin of olefin system is 1.5593 to the wavelength of 405 nm, 1.5406 to the wavelength of 655 nm and 1.5371 to the wavelength of 785 nm.

As shown in FIG. 7, when the diffraction order is varied as the first, the second, the third, and the like to the laser beam L_{CD} with the wavelength of 785 nm, the blaze height corresponding to the diffraction order varies as 1.461553 μm, 2.923106 μm, 4.384658 μm and the like. When the diffraction order is varied as the first, the second, the third, and the like to the laser beam L_{DVD} with the wavelength of 655 nm, the blaze height corresponding to the diffraction order varies as 1.211617 μm, 2.423233 μm, 3.63485 μm and the like. Further, when the diffraction order is varied as the first, the second, the third, and the like to the laser beam L_{BRD} with the wavelength 405 nm, the blaze height corresponding to the diffraction order varies as 0.724119 μm, 1.448239 μm, 2.172358 μm and the like. Therefore, the group is selected that the respective diffraction orders are different and all of the blaze height corresponding to each diffraction order of the laser beam L_{CD} with the wavelength of 785 nm and the blaze height corresponding to each diffraction order of the laser beam L_{DVD} with the wavelength of 655 nm, and the blaze height corresponding to each diffraction order of the laser beam L_{BRD} with the wavelength of 405 nm approximate to each other, in other words, are approximately equal to each other. Accordingly, the value coincided with or approximated to the respective blaze heights is set to be the blaze height “h”.

For example, in the group “B1” shown in FIG. 7, when the diffraction order of the laser beam L_{CD} with the wavelength of 785 nm is set in the third order, its corresponding blaze height is 4.384658 μm, when the diffraction order of the laser beam L_{DVD} with the wavelength of 655 nm is set in the fourth order, its corresponding blaze height is 4.846467 μm, and when the diffraction order of the laser beam L_{BRD} with the wavelength of 405 nm is set in the sixth order, its corresponding blaze height is 4.344717 μm. All three of the blaze heights approximate to each other or are approximately equal to each other. Accordingly, the value coincided with or approximated to all three blaze heights is set to be the blaze height “h” of the center side diffraction grating 370, the intermediate diffraction grating 380 and the most outer peripheral side diffraction grating 390.

In this case, the simple average of the three blaze heights may be used as the blaze height “h”, but preferably the average obtained after performing weighting based on the respective priority degrees may be used. In addition, since the laser beam L_{BRD} with the shorter wavelength is used for a high recording density, the blaze height “h” may be preferably coincided with or approximated to 4.344717 μm, which is the blaze height corresponding to the sixth diffracted light of the laser beam L_{BRD}, by giving priority to the BRD.

When the blaze height “h” is determined based on the calculation results shown in FIG. 7, the groups “B2” or “B3” may be used in addition to the group “B1” shown in FIG. 7. In this case, when the group B1 is adopted, the blaze height “h” is about 4.4˜4.8 μm, when the group B2 is adopted, the blaze height “h” is about 5.8˜6.0 μm and, when the group B3 is adopted, the blaze height “h” is about 7.2˜7.3 μm. As described above, when the blaze height “h” is set to be low, the diffracted light whose diffraction order is small is used. Therefore, the number of blaze can be increased and a higher diffraction efficiency can be obtained.

Further, in the calculation results shown in FIG. 7, when the laser beam with a longer wavelength is defined as a first laser beam and the laser beam with a shorter wavelength is defined as a second laser beam in either two types of light beams of the three kinds of laser beams L_{CD}, L_{DVD} and L_{BRD}, it is preferable to use a group in which the values “m₁” and “m₂” used in the conditional expressions (1) and (2) satisfy the following conditional expression: m₂=m₁−1. In other words, it is preferable to use a group in which the order of diffracted light of the laser beam for CD is lower by one order than that of the laser beam for DVD, or the order of diffracted light of the laser beam for DVD is lower by one order than that of the laser beam for BRD.

As described above, in the second embodiment, different focal positions are formed with the diffraction parallel use type objective lens 3 by using three laser beams L_{CD}, L_{DVD} and L_{BRD} with different wavelengths. Therefore, even when the laser beams L_{CD}, L_{DVD} and L_{BRD} converge on the optical recording media with different thickness of the transparent protective layer, the difference of the thicknesses of transparent protective layers is not required to compensate with a positional shift in the focus direction of the objective lens (optical axis direction of the objective lens). Therefore, in the movable range of the objective lens in the focus direction, the lens shift amount due to the thickness difference of the transparent protective layers of the optical recording media is not required to be added to the operating distance for a normal focus control, and thus the thickness of the optical head device can be reduced. In the second embodiment, the same blaze height “h” is set in all of the center side diffraction grating 370, the intermediate diffraction grating 380 and the most outer peripheral side diffraction grating 390. However, since the orders of the diffracted lights used in three types of laser beams L_{CD}, L_{DVD} and L_{BRD} with different wavelengths differ from each other, a high degree of diffraction efficiency can be set for either of the laser beams L_{CD}, L_{DVD} and L_{BRD}. According to the second embodiment, the similar effects as the first embodiment, for example, that a high degree of utilization efficiency of the light beam is attained, are obtained.

In the second embodiment of the present invention, when the laser beam with a longer wavelength is defined as a first laser beam and the laser beam with a shorter wavelength is defined as a second laser beam in either two of light beams of the three types of laser beams L_{CD}, L_{DVD} and L_{BRD}, the blaze height “h” is set to satisfy the conditional expressions (1) and (2). Alternatively, in selected only two of the three types of laser beams L_{CD}, L_{DVD} and L_{BRD}, when the laser beam with a longer wavelength is defined as a first laser beam and the laser beam with a shorter wavelength is defined as a second laser beam, the blaze height “h” is set to satisfy the conditional expressions (1) and (2).

For example, the blaze height “h” of the center side diffraction grating 370, the intermediate diffraction grating 380 and the most outer peripheral side diffraction grating 390 may be set by using the values in the group “B0” shown in FIG. 7. In the group “B0” shown in FIG. 7, the diffraction order of the laser beam L_{CD} and that of the laser beam L_{DVD} are the same, but the diffraction order of the laser beam L_{DVD} is different from that of the laser beam L_{BRD}.

In the first and second embodiments, the present invention is applied to the objective lens 3 or 30 in the optical head device. However, the present invention may be applied to a lens, for example, to the collimator lens 23 through which the laser light beams with different wavelengths pass.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

While the foregoing description and drawings represent the present invention, it will be obvious to those skilled in the art that various changes may be made therein without departing from the true spirit and scope of the present invention.

1. A lens comprising:
a refraction face including an inner side area and an outer peripheral side area surrounding around the inner side area;
a diffraction grating formed on the inner side area and the outer peripheral side area of the refraction face in a concentrically circular shape around its optical axis such that a plurality of light beams with different wavelengths are focused at different positions;
wherein the plurality of light beams include a first light beam, which emits through the inner side area of the refraction face, and a second light beam with a wavelength shorter than a wavelength of the first light beam, which emits through the inner side area and the outer peripheral side area,
wherein the diffraction grating of both the inner side area and the outer peripheral side area is formed so as to have the same blaze height “h”, and the blaze height “h” is set to be coincided with or approximated to both values“h₁” and “h₂”, which are obtained by the following conditional expressions:
h₁=(m₁×λ₁)/(n₁−1) the conditional expression (1):
wherein “m₁” is an integer number of 1 or more,
“λ₁” is a wavelength of the first light beam,
“n₁” is a refractive index of the refraction face to the first light beam,
h₂=(m₂×λ₂)/(n₂−1) the conditional expression (2):
wherein “m₂” is an integer number more than “m₁”,
“λ₂” is a wavelength of the second light beam,
“n₂” is a refractive index of the refraction face to the second light beam.

2. The lens according to claim 1, wherein the blaze height “h” substantially coincides with one of the values “h₁” and “h₂” and approximates to the other of the values “h₁” and “h₂”.

3. The lens according to claim 1, wherein the blaze height “h” is set at a value between the value “h₁” (included) and the value “h₂” (included).

4. The lens according to claim 1, wherein the light beams are two types of light beams with different wavelengths.

5. The lens according to claim 1, wherein the light beams are three types of light beams with different wavelengths and two of three types of the light beams satisfy the conditional expressions (1) and (2).

6. The lens according to claim 1, wherein the light beams are three types of light beams with different wavelengths and either two of the three types of the light beams satisfy the conditional expressions (1) and (2).

7. The lens according to claim 1, wherein the light beams include at least light beams used for recording or reproduction for a CD or a DVD, and either one of boundaries between the inner side area and its outside and between the outer peripheral side area and its outside corresponds to a numerical aperture of the light beam being used for recording or reproduction for the CD or the DVD.

8. The lens according to claim 1, wherein the light beams include at least a light beam used for recording or reproduction for a CD as the first light beam and a light beam used for recording or reproduction for a DVD as the second light beam, and the values “m₁” and “m₂” satisfy the following conditional expression: m₂=m₁−1.

9. The lens according to claim 8, wherein the blaze height “h” substantially coincides with the value “h₂” and approximates to the value “h₁”.

10. An optical head device including an objective lens,
wherein the objective lens comprises:
a refraction face including an inner side area and an outer peripheral side area surrounding the inner side area; and
a diffraction grating formed on the inner side area and the outer peripheral side area of the refraction face in a concentrically circular shape around its optical axis such that a plurality of light beams with different wavelengths are focused at different positions;
wherein the plurality of light beams include a first light beam, which emits through the inner side area of the refraction face to converge on a recording surface of a first optical recording medium, and a second light beam with a wavelength shorter than a wavelength of the first light beam, which emits through the inner side area and the outer peripheral side area to converge on a recording surface of a second optical recording medium, which has a transparent protective layer covering the recording surface whose thickness is thinner than a thickness of the first optical recording medium,
wherein the diffraction grating of both the inner side area and the outer peripheral side area is formed so as to have the same blaze height “h”, and the blaze height “h” is set to be coincided with or approximated to both the values “h₁” and “h₂”, which are obtained by the following conditional expressions:
h₁=(m₁×λ₁)/(n₁−1) the conditional expression (1):
wherein “m₁” is an integer number of 1 or more,
“λ₁” is a wavelength of the first light beam,
“n₁” is a refractive index of the refraction face to the first light beam,
h₂=(m₂×λ₂)/(n₂−1) the conditional expression (2):
wherein “m₂” is an integer number more than “m₁”,
“λ₂” is a wavelength of the second light beam,
“n₂” is a refractive index of the refraction face to the second light beam.

11. The optical head device according to claim 10, wherein the blaze height “h” substantially coincides with one of the values “h₁” and “h₂” and approximates to the other of the values “h₁” and “h₂”.

12. The optical head device according to claim 10, wherein the blaze height “h” is set in a value between the value “h₁” and the value “h₂”.

13. The optical head device according to claim 10, wherein the light beams are three types of light beams with different wavelengths and two of three types of the light beams satisfy the conditional expressions (1) and (2).

14. The optical head device according to claim 10, wherein the light beams are three types of light beams with different wavelengths and either two of the three types of the light beams satisfy the conditional expressions (1) and (2).

15. The optical head device according to claim 10, wherein the light beams include at least light beams used for recording or reproduction for a CD or a DVD, and either one of boundaries between the inner side area and its outside and between the outer peripheral side area and its outside corresponds to a numerical aperture of the light beam used for recording or reproduction for the CD or the DVD.

16. The optical head device according to claim 10, wherein the light beams include at least a light beam used for recording or reproduction for a CD as the first light beam and a light beam used for recording or reproduction for a DVD as the second light beam, and the values “m₁” and “m₂” satisfy the following conditional expression: m₂=m₁−1.

17. The optical head device according to claim 16, wherein the blaze height “h” substantially coincides with the value “h₂” and approximates to the value “h₁”.
